(19) United States
(12) Patent Application Publication
(10) Pub. No.: US 2024/0328843 A1
(43) Pub. Date: Oct. 3, 2024

(54) LIQUID PURIFICATION UNIT AND LIQUID PURIFICATION SYSTEM

(71) Applicant: ORGANO CORPORATION, Tokyo (JP)

(72) Inventors: Noriko TAKADA, Tokyo (JP); Yukinari YAMASHITA, Tokyo (JP)

(73) Assignee: ORGANO CORPORATION, Tokyo (JP)

(21) Appl. No.: 18/602,241

(22) Filed: Mar. 12, 2024

(30) Foreign Application Priority Data
Mar. 30, 2023 (JP) 2023-056154

(51) Int. Cl. G01F 1/661; B01D 15/00; B01D 61/14; B01D 61/22; B01D 69/02

(52) U.S. Cl. CPC G01F 1/661; B01D 15/00; B01D 61/145; B01D 61/147; B01D 61/22; B01D 69/02; B01D 2311/04; B01D 2313/60; B01D 2325/42

(57) ABSTRACT

Liquid purification unit includes purification device that purifies a flammable liquid, liquid storage tank that stores the liquid supplied to purification device, at least one non-energized sensor that detects the presence or absence of liquid flowing out from liquid storage tank, and housing that accommodates purification device, liquid storage tank, and the at least one non-energized sensor.

### RELATED APPLICATION INFORMATION

This application claims priority to Japanese Patent Application No. 2023-056154, filed on Mar. 30, 2023, which is incorporated herein by reference in its entirety.

### BACKGROUND OF THE INVENTION

### Technical Field

The present invention relates to a liquid purification unit and a liquid purification system.

### Description of the Related Art

Systems for purifying organic solvents are known. Japanese Unexamined Patent Publication No. 2022-50995 discloses an organic solvent purification system that includes a liquid storage tank that stores an organic solvent and a purification device that purifies the organic solvent stored in the liquid storage tank. The purification device is filled with ion exchange resin and other materials.

### SUMMARY

In systems that process flammable liquids such as organic solvents, explosion-proofing of the system is required to prevent the liquid from igniting or exploding. Consequently, facilities containing flammable liquids such as liquid storage tanks and purification devices may be accommodated in a strong housing made of steel or the like. Furthermore, it is desirable that no energized equipment that could cause the liquid to ignite or explode be installed inside the housing. For this reason, the installation of measuring instruments inside the housing is restricted, and it may therefore be difficult to accurately comprehend the distribution and status of movement of the liquid in the housing.

An object of the present invention is to provide a liquid purification unit that can easily comprehend the distribution and movement status of flammable liquid in a housing.

A liquid purification unit of the present invention comprises a purification device that purifies flammable liquid, a liquid storage tank that stores the liquid that is supplied to the purification device, at least one non-energized sensor that detects the presence or absence of liquid flowing out from the liquid storage tank, and a housing that accommodates the purification device, the liquid storage tank, and the at least one non-energized sensor.

According to the present invention, it is possible to provide a liquid purification unit that can easily comprehend the distribution and the status of movement of flammable liquid in a housing.

The above and other objects, features and advantages of the present invention will become apparent from the following description with reference to the accompanying drawings that illustrate examples of the present invention.

### BRIEF DESCRIPTION OF DRAWINGS

FIG. 1 is a conceptual diagram of a purification process of a liquid purification system according to a first embodiment.

FIG. 2 is a conceptual diagram of an organic solvent replenishment process of the liquid purification system according to the first embodiment.

FIG. 3 is a conceptual diagram of a purification process of a liquid purification system according to a second embodiment.

FIG. 4 is a conceptual diagram of an organic solvent replenishment process of the liquid purification system according to the second embodiment.

FIG. 5 is a conceptual diagram of a liquid purification unit according to a third embodiment.

### DETAILED DESCRIPTION OF PREFERRED EMBODIMENTS

Hereinafter, some embodiments of a liquid purification unit and a liquid purification system of the present invention will be described with reference to the drawings. The liquid purification unit and the liquid purification system of the present invention are used to purify flammable liquids, especially organic solvents. Although liquid purification units 1A to 1C in the following embodiments are intended for relatively small units for purifying organic solvents for analysis, the present invention can also be applied to large-scale plants that purify large amounts of flammable liquids. The scale of the units is not particularly limited.

### First Embodiment

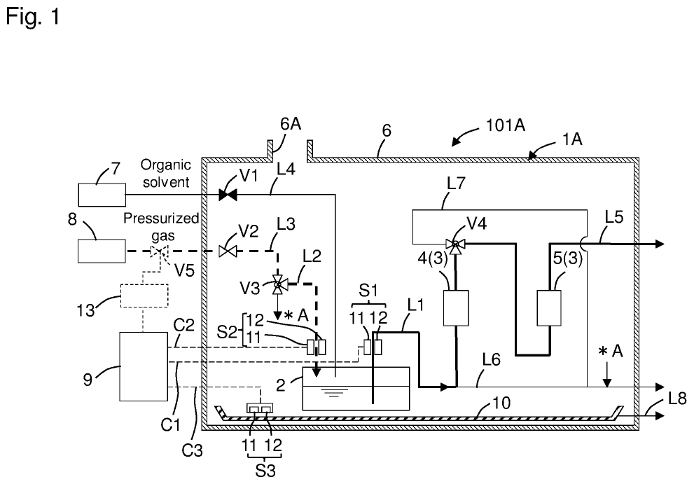

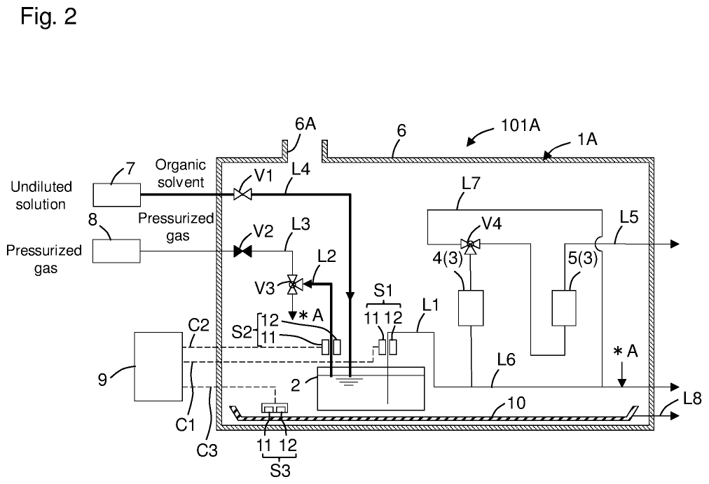

FIGS. 1 and 2 show a schematic configuration of liquid purification unit 1A according to the first embodiment. In FIG. 1, the flow of liquid in a purification process is shown by a thick solid line, and the flow of pressurized gas is shown by a thick broken line, and in FIG. 2, the flow of liquid in a liquid replenishment process is shown by a thick solid line. The combination of liquid purification unit 1A and receiver 9 is referred to as liquid purification system 101A. Liquid purification unit 1A includes purification device 3 that purifies a flammable liquid and liquid storage tank 2 that stores the liquid supplied to purification device 3. The liquid to be purified is an organic solvent but is not limited to organic solvents. No particular limitations apply to the liquid to be purified as long as it is a flammable liquid.

Purification device 3 includes filter device 5 and granular material-filled device 4 that is filled with a granular material composed of at least one of ion exchanger, activated carbon, synthetic adsorbent, and zeolite. Granular material-filled device 4 and filter device 5 are arranged in series along first liquid supply pipe L1. Although not shown, a plurality of granular material-filled devices 4 and/or a plurality of filter devices 5 may be arranged in parallel. Filter device 5 includes, for example, a microfiltration membrane or an ultrafiltration membrane. Filter device 5 may use a filter having an ion exchange group. The configuration of purification device 3 can be appropriately determined according to the cleanliness of the liquid to be purified and the required cleanliness. Liquid storage tank 2 is arranged upstream of purification device 3, and purification device 3 and liquid storage tank 2 are connected by first liquid supply pipe L1. First liquid supply pipe L1 supplies the liquid in liquid storage tank 2 to purification device 3. The liquid purified by purification device 3 is discharged to the outside of housing 6 through purified liquid discharge pipe L5 that passes through housing 6.

Purification device 3 and liquid storage tank 2 are accommodated in housing 6. Since purification device 3 and liquid storage tank 2 contain an organic solvent, which is a flammable liquid, housing 6 is made of metal in order to ensure chemical resistance, strength, and protection against explosion. Opening 6A for exhaust is provided at the top of housing 6, but since housing 6 is made of metal, the inside of housing 6 cannot be visually observed from the outside except for opening 6A for exhaust. Note that the piping and parts described below are also accommodated in housing 6 unless otherwise noted.

First drain pipe L6 branches from first liquid supply pipe L1 and extends to the outside of housing 6. Second vent pipe L7 branches from between granular material-filled device 4 and filter device 5 of first liquid supply pipe L1 and joins first drain pipe L6. Second vent pipe L7 is provided to exhaust air inside granular material-filled device 4 when granular material-filled device 4 is being refilled with liquid after granular material-filled device 4 has been emptied for maintenance or the like. Further, second vent pipe L7 can be used to discharge waste liquid generated in initial cleaning that is performed to remove air and particulate impurities contained within the granular material. Three-way valve V4 is installed at the branch part of second vent pipe L7 of first liquid supply pipe L1 to switch between the process of discharging air inside granular material-filled device 4 and the purification process.

Liquid supply section 7 is provided outside housing 6, and liquid supply section 7 is connected to liquid storage tank 2 by second liquid supply pipe L4 that passes through housing 6. Second liquid supply pipe L4 supplies liquid to liquid storage tank 2. Liquid processing is performed by batch processing, and valve V1 that is provided in second liquid supply pipe L4 remains closed until a certain amount of liquid stored in liquid storage tank 2 is processed by purification device 3. Valve V1 is a manual valve, and an operation unit (not shown) such as a handle is provided outside housing 6.

Pressurized gas supply unit 8 such as a cylinder is provided outside housing 6, and pressurized gas supply unit 8 is connected to liquid storage tank 2 by pressurized gas supply pipe L3 that passes through housing 6. Pressurized gas supply pipe L3 supplies pressurized gas to liquid storage tank 2. The pressurized gas is used to pressurize the liquid inside liquid storage tank 2 and send it to purification device 3. An inert gas such as nitrogen gas or air is used as the pressurized gas. Pressurized gas supply pipe L3 is provided with valve V2 for controlling the supply of pressurized gas. An operating section (not shown) of valve V2 is provided outside housing 6. The flow rate of the liquid supplied to purification device 3 can be controlled by adjusting the supply pressure of the pressurized gas using pressurized gas supply unit 8 or valve V2.

Liquid storage tank 2 is provided with first vent pipe L2 that communicates with the inside of liquid storage tank 2 and extends upward from liquid storage tank 2. First vent pipe L2 is provided to exhaust the air inside liquid storage tank 2 in the liquid replenishment process, but first vent pipe L2 is also used to supply pressurized gas to liquid storage tank 2 in the purification process. In other words, in the purification process, the pressurized gas is supplied to liquid storage tank 2 through pressurized gas supply pipe L3 and first vent pipe L2. Since pressurized gas supply pipe L3 is connected to first vent pipe L2, the amount of piping material can be reduced. In order to switch between the purification process and the liquid replenishment process, three-way valve V3 is provided at the confluence part of pressurized gas supply pipe L3 and first vent pipe L2. First vent pipe L2 is connected to first drain pipe L6 (see A in FIGS. 1 and 2).

Drain pan 10 is installed at the bottom of housing 6. Second drain pipe L8 that is connected to drain pan 10 passes through housing 6 to extend outside housing 6. Drain pan 10 is provided to collect and hold the leaked liquid in the unlikely event that liquid leakage should occur in housing 6. Liquid leakage points are not limited and include all containers, devices, and piping that contain liquids. Therefore, drain pan 10 should be installed to cover the entire bottom surface of housing 6 so that it can be installed not only below liquid storage tank 2, granular material-filled device 4, and filter device 5, but also below piping through which liquid flows. The capacity of drain pan 10 is larger than the volume of the flammable liquid present in housing 6. A waste liquid tank (not shown) may be provided at the end of second drain pipe L8 outside housing 6, and the liquid accumulated in drain pan 10 may be automatically or manually discharged to the waste liquid tank.

The inner surfaces of each of first liquid supply pipe L1, second liquid supply pipe L4, and purified liquid discharge pipe L5 are formed of fluororesin. Similarly, the inner surface of liquid storage tank 2, the inner surface of the casing of granular material-filled device 4, and the inner surface of the casing of filter device 5 are also formed of fluororesin. As raw material liquids or purified liquids pass through these pipes, tanks, and casings, at least parts that contact the liquid are formed of fluororesin, which has excellent chemical resistance and resists contamination, so as to achieve high-purity purification in which impurity concentrations can be reduced to the ppt level or lower. Examples of the fluororesin include perfluoroalkoxyalkane (PFA) and polytetrafluoroethylene (PTFE). Since liquid does not flow through pressurized gas supply pipe L3, there is no need to form the inner surface with fluororesin. Drain pan 10 and first and second drain pipes L6 and L8 have parts that contact liquid, and if the discharged liquid is to be recovered and purified, at least the parts that contact liquid are preferably made of fluororesin.

Housing 6 accommodates at least one non-energized sensor, and in this embodiment, housing 6 accommodates first to third sensors S1 to S3. These sensors can be combined as appropriate according to the required specifications of liquid purification unit 1A. For example, only first sensor S1 and second sensor S2 can be provided, or first to third sensors S1 to S3 can all be provided. Receiver 9 that receives signals from the first to third sensors S1 to S3 is provided outside housing 6. First to third sensors S1 to S3 are optical sensors, and receiver 9 and first to third sensors S1 to S3 are connected by optical cables C1 to C3, respectively, that pass through housing 6. The types and configurations of first to third sensors S1 to S3 are not limited as long as these sensors are non-energized.

Since first to third sensors S1 to S3 are non-energized, they will not constitute an ignition source in housing 6. Circuits (not shown) required for operating first to third sensors S1 to S3, specifically, a circuit for generating the light that is emitted from first to third sensors S1 to S3 and a circuit for receiving the light that is returned from first to third sensors S1 to S3, require a power supply, but these circuits are provided in receiver 9, which is a non-hazardous location outside housing 6.

First sensor S1 is attached to first liquid supply pipe L1. First sensor S1 includes light emitting section 11 and light receiving section 12 that are attached on either side of first liquid supply pipe L1 so as to sandwich first liquid supply pipe L1. A portion of first liquid supply pipe L1 to which first sensor S1 (light emitting section 11 and light receiving section 12) is attached is formed of a transparent member. Since the refractive index of the light emitted from light emitting section 11 changes depending on the type of medium between light emitting section 11 and light receiving section 12, the type of medium between light emitting section 11 and light receiving section 12 is determined based on the change in the amount of light received at light receiving section 12. In other words, first sensor S1 can detect whether the medium present between light emitting section 11 and light receiving section 12 is liquid or gas. Therefore, first sensor S1 determines the presence or absence of liquid inside first liquid supply pipe L1 at the position at which first sensor S1 is attached, and more specifically, the presence or absence of liquid flowing out from liquid storage tank 2 to first liquid supply pipe L1 at the position at which first sensor S1 is attached.

Second sensor S2 is attached to first vent pipe L2. Second sensor S2 includes light emitting section 11 and light receiving section 12 that are attached on either side of first vent pipe L2 so as to sandwich first vent pipe L2. A portion of first vent pipe L2 to which second sensor S2 (light emitting section 11 and light receiving section 12) is attached is formed of a transparent member or semitransparent member. Based on the same principle as for first sensor S1, second sensor S2 detects the presence or absence of liquid inside first vent pipe L2 at the position at which second sensor S2 is attached, and more specifically, the presence or absence of liquid flowing out from liquid storage tank 2 to first vent pipe L2 at the position at which second sensor S2 is attached

Third sensor S3 is attached near the bottom of housing 6 and above drain pan 10. In third sensor S3, light emitting section 11 and light receiving section 12 are combined into one package, and light receiving section 12 receives reflected light of the light that is emitted from light emitting section 11 and reflected by the medium. Third sensor S3 can detect the presence or absence of liquid between third sensor S3 and the bottom of housing 6, and more specifically, between third sensor S3 and drain pan 10.

First sensor S1 is a non-contact type sensor in which light emitting section 11 and light receiving section 12 are provided outside first liquid supply pipe L1 and first sensor S1 therefore does not come into contact with liquid. Similarly, second sensor S2 is a non-contact type sensor in which light emitting section 11 and light receiving section 12 are provided outside first vent pipe L2 and second sensor S2 therefore does not come into contact with liquid. Third sensor S3 is preferably arranged at a position vertically above second drain pipe L8 that does not come into contact with liquid. Since first to third sensors S1 to S3 are all installed separately from the liquid, contamination of the liquid by first to third sensors S1 to S3 can be prevented, and high-purity purification is possible.

Liquid purification system 101A configured as described above operates as next described. Referring to FIG. 1, in the purification process, pressurized gas is supplied from pressurized gas supply unit 8 to liquid storage tank 2 through pressurized gas supply pipe L3 and first vent pipe L2. The liquid stored in liquid storage tank 2 is pressurized by the pressurized gas and sent to purification device 3 (granular material-filled device 4 and filter device 5) through first liquid supply pipe L1. The liquid is purified by the removal of ionic substances and particulates in purification device 3 and is discharged to the outside of housing 6 through purified liquid discharge pipe L5. Examples of pressurized gases include compressed air and inert gases such as nitrogen.

As described above, since the purification process is performed by a batch process, the amount of liquid stored in liquid storage tank 2 decreases with time. As the liquid stored in liquid storage tank 2 further decreases, air displaced from the liquid in liquid storage tank 2 enters first liquid supply pipe L1. In the initial stage, a mixed flow of liquid and air flows through first liquid supply pipe L1, or liquid and air flow alternately, and in the final stage, only air flows. When air that enters first liquid supply pipe L1 reaches granular material-filled device 4, a portion of the liquid within the granular material is replaced by air, and the possibility increases that the time during which the liquid contacts the granular material is reduced or that the liquid flows out of granular material-filled device 4 without being sufficiently diffused into the granular material. Similarly, as the air that enters first liquid supply pipe L1 reaches filter device 5, the possibility increases that a portion of the liquid in contact with the membrane surface of the filter is replaced by air and the contact area between the liquid and the filter is reduced, thereby decreasing the filtration efficiency.

Therefore, if air enters purification device 3, the air should be extruded from purification device 3 before starting the next batch process. Although a portion of the air can be purged from second vent pipe L7, in order to substantially fill the inside of purification device 3 with liquid, this procedure necessitates a lengthy operation for the passage of liquid, and this procedure leads to a decrease in purification efficiency. For this reason, it is desirable to reduce the infiltration of air into purification device 3. Due to the difficulty of monitoring the inside of the housing, an operation has conventionally been performed in which, after performing purification for a predetermined period of time, the housing is opened to exchange liquid storage tank 2 from which liquid has been consumed with liquid storage tank 2 that is filled with liquid. However, this operation is time-consuming, and further, necessitates early replacement of liquid storage tank 2 and thus leads to a decrease in purification efficiency.

In this embodiment, first sensor S1 attached to first liquid supply pipe L1 detects the presence or absence of liquid inside first liquid supply pipe L1. As described above, in the initial stage, a mixed flow of liquid and air flows through first liquid supply pipe L1 or liquid and air alternately flow, but even at this stage, first sensor S1 can detect the air based on the presence or absence of liquid. Air can of course be detected when only air flows through first liquid supply pipe L1. Receiver 9 reports the absence of liquid when the signal received from first sensor S1 is a signal indicating the absence of liquid. The method of notification may include a lamp that lights or flashes, a buzzer, a sound, an indication on a display, signal transmission to another terminal, or a combination of these methods, the method not being limited as long as the operator is able to recognize the absence of liquid. Based on the notification, the operator can recognize that liquid storage tank 2 is almost empty. The operator is therefore able to stop the supply of pressurized gas by activating the operation unit of valve V2 of pressurized gas supply pipe L3, which is located outside housing 6, and as a result, the possibility of air entering purification device 3 can be reduced.

Alternatively, when the signal received from first sensor S1 indicates the absence of liquid, means may be provided for automatically stopping the supply of pressurized gas. For example, as shown by the broken line in FIG. 1, this means may include solenoid valve V5 that is provided in a non-hazardous location of pressurized gas supply pipe L3 that is outside housing 6 and controller 13 that is provided outside housing 6 and that controls the opening and closing of solenoid valve V5. Controller 13 is electrically connected to receiver 9, and when the signal received from receiver 9 is a signal indicating the absence of liquid, controller 13 transmits a command to electromagnetic valve V5 to close electromagnetic valve V5. Furthermore, leakage of liquid to drain pan 10 can be minimized by providing means for automatically stopping the supply of pressurized gas when third sensor S3 detects liquid.

If the signal received from first sensor S1 is a signal indicating the presence of liquid, receiver 9 may, but need not, transmit a report, because this signal only means that liquid is being sent from liquid storage tank 2 to purification device 3. By analyzing the signal history, receiver 9 can determine, for example, the time that a liquid starts to be passed and the time after the start of passage of the liquid, and the time of liquid passage and the amount of liquid passed can therefore be easily managed.

When liquid storage tank 2 is almost empty, a liquid replenishment process is performed to replenish liquid storage tank 2 with liquid for the next batch process. Referring to FIG. 2, valve V2 is closed and valve V1 is opened to supply liquid from liquid supply section 7 to liquid storage tank 2 via second liquid supply pipe L4. Air in liquid storage tank 2 is purged through first vent pipe L2 and replaced with liquid. When liquid storage tank 2 is filled with a predetermined amount of liquid, liquid flows out of liquid storage tank 2 and flows into first vent pipe L2. Second sensor S2 detects the liquid inside first vent pipe L2. When the signal received from second sensor S2 is a signal indicating the presence of liquid, receiver 9 reports the presence of liquid. The notification method is the same as in the case of first sensor S1. Based on the report, the operator can recognize that liquid storage tank 2 is almost filled with liquid. The operator can therefore stop the supply of liquid by activating the operation unit of valve V1 of second liquid supply pipe L4, which is located outside housing 6. Furthermore, since first vent pipe L2 is connected to first drain pipe L6, the possibility that liquid will flow out (leak) from liquid storage tank 2 is extremely low.

In the unlikely event that liquid leaks inside housing 6, the leaked liquid is captured in drain pan 10. Third sensor S3 detects the liquid held in drain pan 10 and reports in the same manner as first and second sensors S1 and S2. The operator can stop or check liquid purification system 1A as needed.

### Second Embodiment

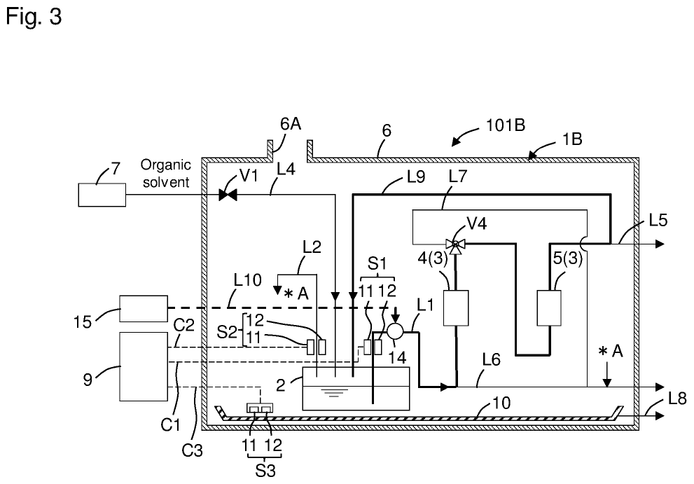

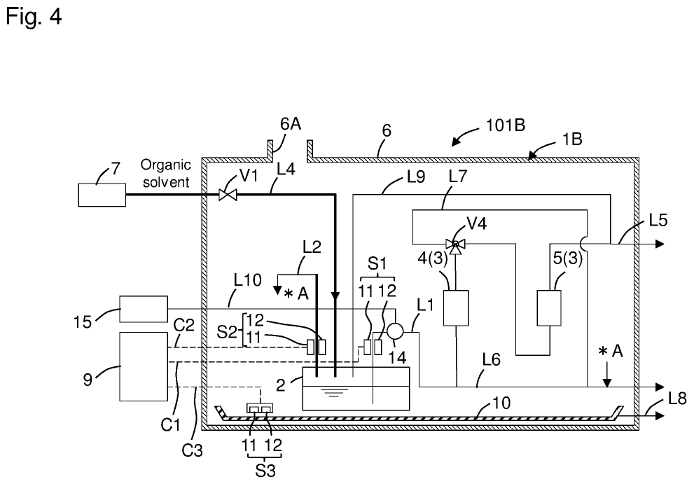

FIGS. 3 and 4 show a schematic configuration of liquid purification unit 1B according to the second embodiment. In FIG. 3, the flow of liquid in the purification process is shown by a thick solid line and the flow of pressurized gas is shown by a thick broken line, and in FIG. 4, the flow of liquid in the liquid replenishment process is shown by a thick solid line. Here, explanation will mainly focus on the differences from the first embodiment. Explanation of configurations and effects that are the same as those of the first embodiment will be omitted. Similar to the first embodiment, the combination of liquid purification unit 1B and receiver 9 is referred to as liquid purification system 101B.

Liquid purification unit 1B includes return pipe L9 that connects purification device 3 and liquid storage tank 2 and that returns the purified liquid that is produced by purification device 3 to liquid storage tank 2. That is, liquid purification unit 1B of the present embodiment purifies the liquid while circulating the liquid along circulation paths L1 and L9 that consist of first liquid supply pipe L1 and return pipe L9. Liquid purification unit 1B includes diaphragm pump 14 for circulating the liquid. Diaphragm pump 14 is provided on first liquid supply pipe L1 and sends the liquid to purification device 3. Diaphragm pump 14 is a type of positive displacement pump that uses a pressurized gas such as an inert gas such as nitrogen or air to move a diaphragm and thus discharge liquid. The pressurized gas is supplied to diaphragm pump 14 from outside housing 6 through working fluid supply pipe L10. Diaphragm pump 14 is preferably of a non-energized air-driven type. When a pressurized gas such as nitrogen or air is supplied, the diaphragm moves so that the pump chamber volume decreases due to the pressure of the pressurized gas, and when the supply of pressurized gas is stopped, the diaphragm moves back so that the pump chamber volume expands. The part of diaphragm pump 14 that comes in contact with liquid is preferably made of fluororesin similarly to the piping and the casing. Liquid purification unit 1B includes controller 15 for controlling the supply of working fluid, and controller 15 is provided outside housing 6. Consequently, there is no need to provide a current-carrying unit inside housing 6. Controller 15 may be integrated with receiver 9. The flow rate of the liquid supplied to purification device 3 can be controlled by using controller 15 to adjust the supply pressure and supply timing of the working fluid.

Liquid purification system 101B configured as described above operates as next described. Referring to FIG. 3, in the purification process, the working fluid is supplied to diaphragm pump 14 through working fluid supply pipe L10. The liquid circulates along circulation paths L1 and L9, and the liquid is purified. Although first sensor S1 can detect that the liquid in circulation paths L1 and L9 has decreased for some reason and that air is mixed in, first sensor S1 may also be omitted. After the passage of a predetermined period of time, the supply of the working fluid is stopped, a valve not shown is operated to switch return pipe L9 to purified liquid discharge pipe L5, and the purified liquid is discharged to outside housing 6. At this time, the supply of gas to diaphragm pump 14 is stopped when first sensor S1 detects air to at least prevent the entry of air into granular material-filled device 4 and filter device 5. A solenoid valve is provided in the pressurized gas supply unit that is provided outside, and means for automatically stopping the supply of pressurized gas can be provided when the signal received from sensor S1 is a signal indicating the absence of liquid. Further, even during circulation and purification, leakage to drain pan 10 can be minimized by providing means for automatically stopping the supply of pressurized gas when third sensor S3 detects liquid.

A liquid replenishment process is subsequently performed to replenish liquid storage tank 2 with liquid for the next batch process. Referring to FIG. 4, valve V1 is opened to supply the liquid from liquid supply section 7 to liquid storage tank 2 via second liquid supply pipe L4. The subsequent operations are similar to those in the first embodiment. Second sensor S2 detects that liquid storage tank 2 has been replenished with a predetermined amount of liquid. In the unlikely event that liquid leaks inside housing 6, the occurrence of the leak is detected by third sensor S3.

### Third Embodiment

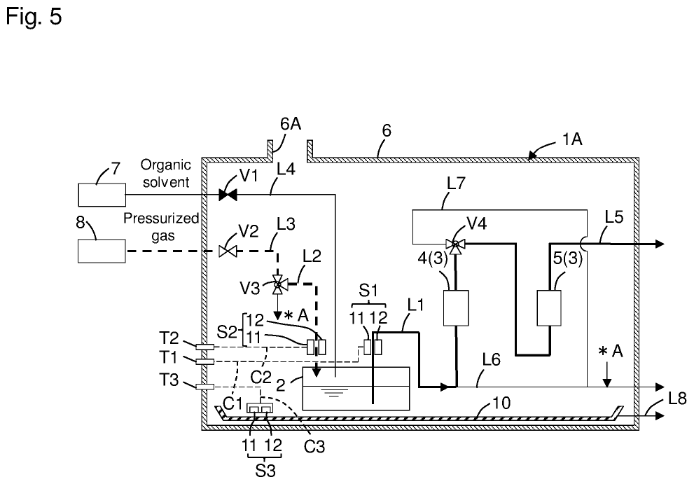

FIG. 5 shows a schematic configuration of liquid purification unit 1C according to the third embodiment. Here, explanation will focus on the differences from the first embodiment. Configurations and effects that are the same as those of the first embodiment will be omitted. In this embodiment, receiver 9 of the first embodiment is not provided, and receiver 9 is separately prepared and connected to liquid purification unit 1C. Consequently, housing 6 of liquid purification unit 1C includes first to third output terminals T1 to T3 for connecting first to third optical cables C1 to C3 to the outside. First to third output terminals T1 to T3 are, for example, optical fiber couplers. First to third optical cables C1 to C3 extend inside housing 6 between first to third sensors S1 to S3 and first to third output terminals T1 to T3, respectively.

Although certain preferred embodiments of the present invention have been shown and described in detail, it should be understood that various changes and modifications may be made without departing from the spirit or scope of the appended claims.

What is claimed is:

1. A liquid purification unit comprising:
a purification device that purifies flammable liquid;
a liquid storage tank that stores the liquid that is supplied to the purification device;
at least one non-energized sensor that detects presence or absence of the liquid flowing out from the liquid storage tank; and
a housing that accommodates the purification device, the liquid storage tank, and the at least one non-energized sensor.

2. The liquid purification unit according to claim 1, wherein the at least one non-energized sensor is an optical sensor, said unit comprising:
an optical cable that is connected to the optical sensor; and
an output terminal that is provided in the housing and that is connected to the optical cable.

3. A liquid purification system comprising:
the liquid purification unit according to claim 1; and
a receiver that is provided outside the housing and that receives a signal from the at least one non-energized sensor, wherein
the at least one non-energized sensor is an optical sensor, and
said system comprises an optical cable that connects the optical sensor and the receiver.

4. The liquid purification unit according to claim 1, further comprising a first liquid supply pipe that connects the purification device and the liquid storage tank and that supplies the liquid in the liquid storage tank to the purification device, wherein
the at least one non-energized sensor includes a first sensor that is attached to the first liquid supply pipe, and
the first sensor detects presence or absence of the liquid inside the first liquid supply pipe at a position at which the first sensor is attached.

5. A liquid purification system comprising:
the liquid purification unit according to claim 4; and
a receiver that is provided outside the housing and that receives a signal from the first sensor,
wherein the receiver reports the absence of the liquid when the signal that is received from the first sensor is a signal that indicates the absence of the liquid.

6. The liquid purification unit according to claim 4, further comprising:
a pressurized gas supply pipe that supplies a pressurized gas to the liquid storage tank for pressurizing the liquid inside the liquid storage tank and for delivering the liquid to the purification device; and
means for stopping the supply of the pressurized gas when the signal that is received from the first sensor is a signal that indicates the absence of the liquid.

7. The liquid purification unit according to claim 1, further comprising:
a second liquid supply pipe that is connected to the liquid storage tank and that supplies the liquid to the liquid storage tank; and
a vent pipe that communicates with an interior of the liquid storage tank and that extends upward from the liquid storage tank, wherein
the at least one non-energized sensor includes a second sensor that is attached to the vent pipe, and
the second sensor detects presence or absence of the liquid inside the vent piping at a position at which the second sensor is attached.

8. A liquid purification system comprising:
the liquid purification unit according to claim 7; and
a receiver that is provided outside the housing and that receives a signal from the second sensor,
wherein the receiver reports the presence of the liquid when the signal that is received from the second sensor is a signal that indicates the presence of the liquid.

9. The liquid purification unit according to claim 1, wherein the at least one non-energized sensor includes a third sensor that is attached near a bottom of the housing,
wherein the third sensor detects presence or absence of the liquid between the third sensor and the bottom.

10. A liquid purification system comprising:
the liquid purification unit according to claim 9; and
a receiver that is provided outside the housing and that receives a signal from the third sensor,
wherein the receiver reports the presence of the liquid when the signal that is received from the third sensor is a signal that indicates the presence of the liquid.
